(19) United States
(12) Patent Application Publication
(10) Pub. No.: US 2014/0189702 A1
(43) Pub. Date: Jul. 3, 2014

(54) SYSTEM AND METHOD FOR AUTOMATIC MODEL IDENTIFICATION AND CREATION WITH HIGH SCALABILITY

(71) Applicant: GENERAL ELECTRIC COMPANY, Schenectady, NY (US)

(72) Inventors: Weizhong Yan, Clifton Park, NY (US); Anil Varma, San Ramon, CA (US); Piero Patrone Bonissone, Schenectady, NY (US); Naresh Sundaram Iyer, Saratoga Springs, NY (US); Feng Xue, Clifton Park, NY (US)

(21) Appl. No.: 13/730,392

(22) Filed: Dec. 28, 2012

(51) Int. Cl. G06F 9/50

(52) U.S. Cl. CPC G06F 9/5027
USPC 718/104

(57) ABSTRACT

A system includes a library of algorithms, and a request module configured to receive an execution request. The system also includes a job scheduler/optimizer module configured to select algorithms from the library and to create at least one execution job based on the algorithms and the execution request. The system further includes a resource module configured to determine execution computing resources from multiple computing sources, including internal computing resources and external computing resources. The system also includes an executor module configured to transmit an execution job to the computing resources.

### BACKGROUND

The field of the invention relates generally to computer-implemented programs and, more particularly, to a computer-implemented system for automatic model identification and creation with high scalability.

Machine Learning, a branch of artificial intelligence, is a science concerned with developing algorithms that analyze empirical, real-world data, searching for patterns in that data in order to create accurate predictions about future events. One critical and challenging part of Machine Learning is model creation, a process of creating a model based on a set of “training data”. This empirical data, observed and recorded, may be used to generalize from those prior experiences. During the model creation process, practitioners find the best model for the given problem through trial and error, that is, generating numerous different models from the training data and choosing one that best meets the performance criteria based on the a set of validation data. Model creation is a complex search problem in the space of model structure and parameters of the various modeling options, and is computationally expensive because of the size of the search space.

The increasing computational complexity of Machine Learning problems requires greater computational capacity, in the form of faster computing resources, more computing resources, or both. In the late 1990's, the SETI@home project implemented a distributed computing mechanism to harness thousands of individual computers to help solve computationally intensive workloads in the Search for Extra-Terrestrial Intelligence (“SETI”). SETI@home needed to analyze massive amounts of observational data from a radio telescope in the search for radio transmissions that might indicate intelligent life in distant galaxies.

Computationally, the problem was divided based on the collected data, parceling the problem into millions of tiny regions of the sky. To process the work load, each tiny region, along with its associated data, was sent out to individual computers on the internet. As each computer finished processing a single tiny region, it would transmit its results back to a central server for collection. For SETI@home, thousands of internet-based computers became a broad distributed computing environment harnessed to solve a computationally complex problem. Similarly, Machine Learning problems represent a computationally complex problem that can also be broken into components and processed with numerous individual computing resources.

In the late 2000's, “Cloud Computing” has emerged as a source of computing resource available to consumers over the internet. Traditionally, if a developer is in need of computational resources, the developer would need to purchase hardware, install the hardware in a datacenter, and install and maintain an operating system on the hardware. Now, various cloud service providers offer a variety of computing resource services available on demand over the internet, such as “Infrastructure as a Service” (“IaaS”) and “Platform as a Service” (“PaaS”).

With IaaS and PaaS, consumers can “rent” individual computers or, more often, “virtual servers”, from the cloud service provider on an as-needed basis. These virtual servers may be pre-loaded with an operating system image, and accessible via the Internet through use of an Application Programming Interface (“API”). For example, a developer with a computationally complex problem could use the cloud service provider's API to provision a virtual server with the cloud service provider, transfer his software code or machine-executable instructions and data to the virtual server, and execute his job. When the job is finished, the developer could retrieve his results, and then shut down the virtual server. These IaaS and PaaS services offer an option to those in need of additional computational resources, but who do not have the regular need, the budget, or the infrastructure for having their own dedicated hardware. For developers who require an agile development environment for Machine Learning computation, cloud computing represents a promising source of computing resources.

### BRIEF DESCRIPTION

In one aspect, a system is provided. The system includes a library comprising a plurality of algorithms. Each algorithm of the plurality of algorithms includes at least one of source code and machine-executable code. The system also includes a request module configured to receive an execution request. The system further includes a job scheduler/optimizer module configured to select a subset of algorithms from the library. The job scheduler/optimizer module also creates at least one execution job based at least partially on at least one algorithm from the subset of algorithms and based at least partially on the execution request. The system also includes a resource module configured to determine a subset of computing resources from a plurality of computing resources. The plurality of computing resources includes one of at least one internal computing resource and at least one external computing resource, and a plurality of external computing resources. The system further includes an executor module configured to transmit the at least one execution job to at least one computing resource of the subset of computing resources.

In a further aspect, a method for executing computer jobs is provided. The method is implemented by at least one computer device including at least one processor and at least one memory device coupled to the at least one processor. The method includes receiving an execution request. The method also includes selecting a subset of algorithms from a library including a plurality of algorithms. Each algorithm in the library includes one of source code and machine-executable code. Selecting a subset of algorithms is based at least partially on the execution request. The method further includes identifying a first set of one or more execution jobs. Each of the first set of one or more execution jobs includes at least one algorithm from the subset of algorithms. The method also includes determining a subset of computing resources from a plurality of computing resources. The plurality of computing resources includes one of at least one internal computing resource and at least one third-party computing resource, and a plurality of third-party computing resources. The method also includes transmitting, by the at least one computer device, at least one of the first set of one or more execution jobs to at least one computing resource of the subset of computing resources. The method further includes receiving an execution result.

In yet another aspect, one or more computer-readable storage media having computer-executable instructions embodied thereon are provided. When executed by at least one processor, the computer-executable instructions cause the processor to receive an execution request. The computer-executable instructions also cause the processor to determine a subset of computing resources from a plurality of computing resources. The plurality of computing resources includes at least one internal computing resource and at least one third-party computing resource, and a plurality of third-party computing resources. The computer-executable instructions further cause the processor to select a subset of algorithms from a library including a plurality of algorithms. Each algorithm in the library is one of source code and machine-executable code. Selecting the subset of algorithms includes selecting based at least in part on the execution request. The computer-executable instructions also cause the processor to identify one or more execution jobs to be executed. Each of the one or more execution jobs includes at least one algorithm from the subset of algorithms. The computer-executable instructions further cause the processor to transmit at least one of the one or more execution jobs to at least one computing resource of the subset of computing resources and receive an execution result.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary computing system that may be used for automatic model identification and creation with high scalability;

FIG. 2 is a diagram of an exemplary application environment which includes a system for automatic model identification and creation with high scalability using the computing system shown in FIG. 1;

FIG. 3 is a diagram of the exemplary application environment shown in FIG. 2 showing the major components of the system for automatic model identification and creation with high scalability shown in FIG. 2;

FIG. 4 is a data flow diagram of an exemplary request module of the system shown in FIG. 3, responsible for receiving and processing a request related to Machine Learning;

FIG. 5 is a data flow diagram of the exemplary job scheduler/optimizer module of the system shown in FIG. 3, responsible for preparing jobs for execution;

FIG. 6 is a data flow diagram of the exemplary executor module and resource module of the system shown in FIG. 3, responsible for assigning jobs to computing resources and transmitting jobs for execution;

FIG. 7 is a block diagram of an exemplary method of automatic model identification and creation by provisioning heterogeneous computing resources for Machine Learning using the system shown in FIG. 3;

FIG. 8 is a block diagram of another exemplary method of provisioning heterogeneous computing resources for Machine Learning using the system shown in FIG. 3;

FIG. 9 is a block diagram showing a first portion of an exemplary database table structure for the system shown in FIG. 3, showing the primary tables used by request module shown in FIG. 3;

FIG. 10 is a block diagram showing a second portion the exemplary database structure for the system 201 shown in FIG. 3, showing the primary tables used by job scheduler/optimizer module shown in FIG. 3; and

FIG. 11 is a block diagram showing a third portion of the exemplary database structure for the system shown in FIG. 3, showing the primary tables used by the executor module and the resource module shown in FIG. 3.

Unless otherwise indicated, the drawings provided herein are meant to illustrate key inventive features of the invention. These key inventive features are believed to be applicable in a wide variety of systems comprising one or more embodiments of the invention. As such, the drawings are not meant to include all conventional features known by those of ordinary skill in the art to be required for the practice of the invention.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that may permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “cloud computing” refers generally to computing services offered over the internet. Also, as used herein, the term “cloud service provider” refers to the company or entity offering or hosting the computing service. There are many types of computing services that fall under the umbrella of “cloud computing,” including “Infrastructure as a Service” (“Iaas”) and “Platform as a Service” (“PaaS”). Further, as used herein, the term “IaaS” is used to refer to the computing service involving offering physical or virtual servers to consumers. Under the IaaS model, the consumer will “rent” a physical or virtual server from the cloud service provider, who provides the hardware but generally not the operating system or any higher-level application services. Moreover, as used herein, the term “PaaS” is used to refer to the computing service offering physical or virtual servers to consumers, but also including operating system installation and support, and possibly some base application installation and support such as a database or web server. Also, as used herein, the terms “cloud computing”, “IaaS”, and “PaaS” are used interchangeably. The systems and methods described herein are not limited to these two models of cloud computing. Any computing service that enables the operation of the systems and methods as described herein may be used.

As used herein, the term “private cloud” refers to a computing resources platform similar to “cloud computing”, as described above, but operated solely for a single organization. For example, and without limitation, a large company may establish a private cloud for its own computing needs. Rather than buying dedicated hardware for various specific internal projects or departments, the company may align its computing resources in the private cloud and allow its developers to leverage computing resources through the cloud model, thereby providing greater leverage of its computing resources across the company.

As used herein, the term “internal computing resources” refers generally to computing resources owned or otherwise available to the entity practicing the systems and methods described herein excluding the public “cloud computing” sources. Also, as used herein, private clouds are also considered internal computing resources. Further, as used herein, the term “external computing resources” includes the public “cloud computing” resources.

As used herein, the term “provisioning” refers to the process of establishing a computing resource for use. In order to make a resource available for use, the resource may need to be “provisioned”. For example, and without limitation, when a user seeks a computing resource such as a virtual server from a cloud service provider, the user engages in a transaction to “provision” the virtual server for the consumer's use for a period of time. “Provisioning” establishes the allocation of the computing resource for the user. In the setting of cloud computing of virtual servers, the “provisioning” process may actually cause the cloud service provider to create a virtual server, and perhaps install an operating system image and base applications on the virtual server, before allowing the user to use the resource. Alternatively, the term “provisioning” is also used to refer to the process of allocating an already-available but currently unused computing resource. For example, a cloud server that has already been “provisioned” from the cloud provider, but is not currently occupied with a computing task, can be referred to as being “provisioned” to a new computing task when it is assigned to that task. Also, as used herein, the terms “assignment”, “allocating”, and “provisioning”, with respect to cloud computing resources, are used interchangeably.

As used herein, the term “releasing” is the corollary to “provisioning.” “Releasing” is the process of relinquishing use of the computing resource. In order to vacate the resource, the resource may need to be “released”. For example, and without limitation, when a user has finished using a virtual server from a cloud service provider, the user “releases” the virtual server. “Releasing” informs the cloud service provider that the resource is no longer needed or in use by user, and that the resource may be re-provisioned.

As used herein, the term “algorithm” refers, generally, to any method of solving a problem. Also, as used herein, the term “model” refers, generally, to an algorithm for solving a problem. Further, as used herein, the terms “model” and “algorithm” are used interchangeably. More specifically, in the context of Machine Learning and supervised learning, “model” includes a dataset gathered from some real-world data source, in which a set of input variables and their corresponding output variables are gathered. When properly configured, the model can act as a predictor for a problem if the model utilizes variables similar to a problem. A model may be one of, without limitation, a one-class classifier, a multi-class classifier, or a predictor. In other contexts, the term “algorithm” may refer to methods of solving other problems, such as, without limitation, design of experiments and simulations. In some embodiments, an “algorithm” includes source code and/or computer-executable instructions that may be distributed and utilized to “solve” the problem through execution by a computing resource.

As used herein, the term “job” is used to refer, generally, to a body of work identified for, without limitation, execution, processing, or computing. The “job” may be divisible into multiple smaller jobs such that, when executed and aggregated, satisfy completion of the “job”. Also, as used herein, the term “job” may also be used to refer to one or more of the multiple smaller jobs that make up a larger job. Further, as used herein, the term “execution job” is used interchangeably with “job”, and may also be used to signify a “job” that is ready for execution.

As used herein, the terms “execution request”, “job request”, and “request” are used, interchangeably, to refer to the computational problem to be solved using the systems and methods described herein.

As used herein, the terms “requirement”, “limitation”, and “restriction” refers generally to a configuration parameter associated with a job request. For example, and without limitation, when a user enters a job request that defines use of a particular model M1, the user has specified a “requirement” that the request be executed using model M1. A “requirement” may also be characterized as a “limitation” or a “restriction” on the job request. For example, and without limitation, when a user enters a job request that restricts processing of the request to only internal computing resources, that restriction may be characterized as both a “requirement” that “only internal computing resources are used,” as well as a “limitation” or “restriction” that “no non-internal computing resources may be used to process the request.”

As used herein, the term “heterogeneous computing resources” refers to a set of computing resources that differ in an aspect of one of operating system, processor configuration (i.e., single-processor versus multi-processor), and memory architecture (i.e., 32-bit versus 64-bit). For example, and without limitation, if a set of computing resources includes System X, which is running the Linux operating system, and System Y, which is running Windows™ Server 2003 operating system, then the set of computing resources is considered “heterogeneous”. Additionally, for example, and without limitation, if a set of computing resources includes System 1, which has a single intel-based processor running the Linux operating system, and System 2, which has four intel-based processors running the Linux operating system, then this set of computing resources is considered “heterogeneous”.

The exemplary systems and methods described herein allow a user to seamlessly leverage a diverse, heterogeneous pool of computing resources to perform computational tasks across various cloud computing providers, internal clouds, and other internal computing resources. More specifically, the system is used to search for optimal computational designs or configurations, such as machine learning models and associated model parameters, by automatically provisioning such search tasks across a variety of computing resources coming from a variety of computing providers. An algorithm database includes various versions of machine-executable code or binaries tailored for the variety of computing resource architectures that might be leveraged. An executor module maintains and communicates with the variety of computing resources through an Application Programming Interface (“API”) module, allowing the system to communicate with various different cloud computing providers, as well as internal computing resources such as a private cloud or a private server cluster. A user can input a request that tailors which algorithms are used to complete the request, as well as specifying computing restrictions to be used for execution. Therefore, the user can submit his computationally intensive job to the system, customized with performance requirements and certain restrictions, and thereby seamlessly leverage a potentially large, diverse, and heterogeneous pool of computing resources.

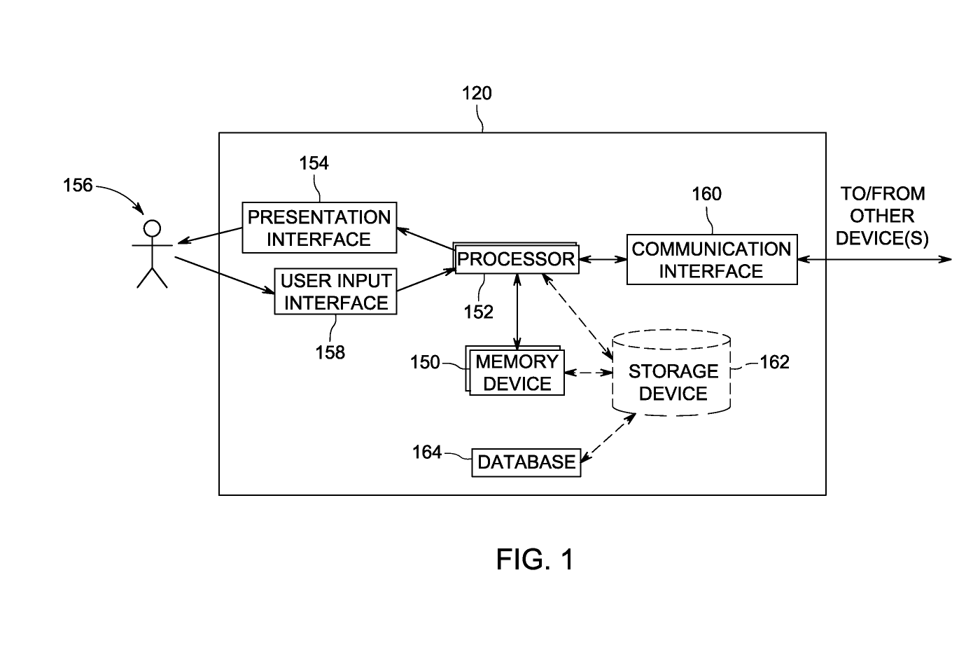

FIG. 1 is a block diagram of an exemplary computing system 120 that may be used for automatic model identification and creation with high scalability. Alternatively, any computer architecture that enables operation of the systems and methods as described herein may be used.

In the exemplary embodiment, computing system 120 includes a memory device 150 and a processor 152 operatively coupled to memory device 150 for executing instructions. In some embodiments, executable instructions are stored in memory device 150. Computing system 120 is configurable to perform one or more operations described herein by programming processor 152. For example, processor 152 may be programmed by encoding an operation as one or more executable instructions and providing the executable instructions in memory device 150. Processor 152 may include one or more processing units, e.g., without limitation, in a multi-core configuration.

In the exemplary embodiment, memory device 150 is one or more devices that enable storage and retrieval of information such as executable instructions and/or other data. Memory device 150 may include one or more tangible, non-transitory computer-readable media, such as, without limitation, random access memory (RAM), dynamic random access memory (DRAM), static random access memory (SRAM), a solid state disk, a hard disk, read-only memory (ROM), erasable programmable ROM (EPROM), electrically erasable programmable ROM (EEPROM), and/or non-volatile RAM (NVRAM) memory. The above memory types are exemplary only, and are thus not limiting as to the types of memory usable for storage of a computer program.

Also, in the exemplary embodiment, memory device 150 may be configured to store information associated with for automatic model identification and creation with high scalability, including, without limitation, Machine Learning models, application programming interfaces, cloud computing resources, and internal computing resources.

In some embodiments, computing system 120 includes a presentation interface 154 coupled to processor 152. Presentation interface 154 presents information, such as a user interface and/or an alarm, to a user 156. For example, presentation interface 154 may include a display adapter (not shown) that may be coupled to a display device (not shown), such as a cathode ray tube (CRT), a liquid crystal display (LCD), an organic LED (OLED) display, and/or a hand-held device with a display. In some embodiments, presentation interface 154 includes one or more display devices. In addition, or alternatively, presentation interface 154 may include an audio output device (not shown) (e.g., an audio adapter and/or a speaker).

In some embodiments, computing system 120 includes a user input interface 158. In the exemplary embodiment, user input interface 158 is coupled to processor 152 and receives input from user 156. User input interface 158 may include, for example, a keyboard, a pointing device, a mouse, a stylus, and/or a touch sensitive panel, e.g., a touch pad or a touch screen. A single component, such as a touch screen, may function as both a display device of presentation interface 154 and user input interface 158.

Further, a communication interface 160 is coupled to processor 152 and is configured to be coupled in communication with one or more other devices, such as, without limitation, another computing system 120, and any device capable of accessing computing system 120 including, without limitation, a portable laptop computer, a personal digital assistant (PDA), and a smart phone. Communication interface 160 may include, without limitation, a wired network adapter, a wireless network adapter, a mobile telecommunications adapter, a serial communication adapter, and/or a parallel communication adapter. Communication interface 160 may receive data from and/or transmit data to one or more remote devices. For example, communication interface 160 of one computing system 120 may transmit transaction information to communication interface 160 of another computing system 120. Computing system 120 may be web-enabled for remote communications, for example, with a remote desktop computer (not shown).

Also, presentation interface 154 and/or communication interface 160 are both capable of providing information suitable for use with the methods described herein, e.g., to user 156 or another device. Accordingly, presentation interface 154 and communication interface 160 may be referred to as output devices. Similarly, user input interface 158 and communication interface 160 are capable of receiving information suitable for use with the methods described herein and may be referred to as input devices.

Further, processor 152 and/or memory device 150 may also be operatively coupled to a storage device 162. Storage device 162 is any computer-operated hardware suitable for storing and/or retrieving data, such as, but not limited to, data associated with a database 164. In the exemplary embodiment, storage device 162 is integrated in computing system 120. For example, computing system 120 may include one or more hard disk drives as storage device 162. Moreover, for example, storage device 162 may include multiple storage units such as hard disks and/or solid state disks in a redundant array of inexpensive disks (RAID) configuration. Storage device 162 may include a storage area network (SAN), a network attached storage (NAS) system, and/or cloud-based storage. Alternatively, storage device 162 is external to computing system 120 and may be accessed by a storage interface (not shown).

Moreover, in the exemplary embodiment, database 164 includes a variety of static and dynamic data associated with, without limitation, Machine Learning models, cloud computing resources, and internal computing resources.

The embodiments illustrated and described herein as well as embodiments not specifically described herein but within the scope of aspects of the disclosure, constitute exemplary means for automatic model identification and creation with high scalability. For example, computing system 120, and any other similar computer device added thereto or included within, when integrated together, include sufficient computer-readable storage media that is/are programmed with sufficient computer-executable instructions to execute processes and techniques with a processor as described herein. Specifically, computing system 120 and any other similar computer device added thereto or included within, when integrated together, constitute an exemplary means for recording, storing, retrieving, and displaying operational data associated with a system (not shown in FIG. 1) for automatic model identification and creation with high scalability.

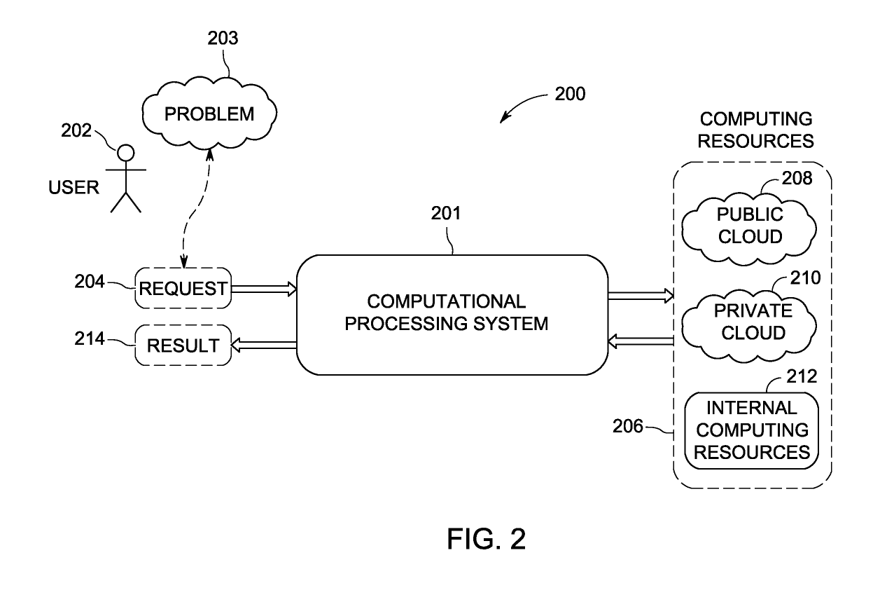

FIG. 2 is a diagram of an exemplary application environment 200 which includes a system 201 for automatic model identification and creation with high scalability using computing system 120 (shown in FIG. 1). A user 202 conceives a problem 203 and submits a request 204 to system 201. System 201 interacts with computing resources 206 in order to process request 204. In the exemplary embodiment, computing resources 206 consist of one or more public clouds 208, one or more private clouds 210, and internal computing resources 212. Operationally, system 201 receives request 204 from user 202 and executes the request automatically across heterogeneous computing resources 206, thereby insulating user 202 from the execution details. The details of system 201 are explained in detail below.

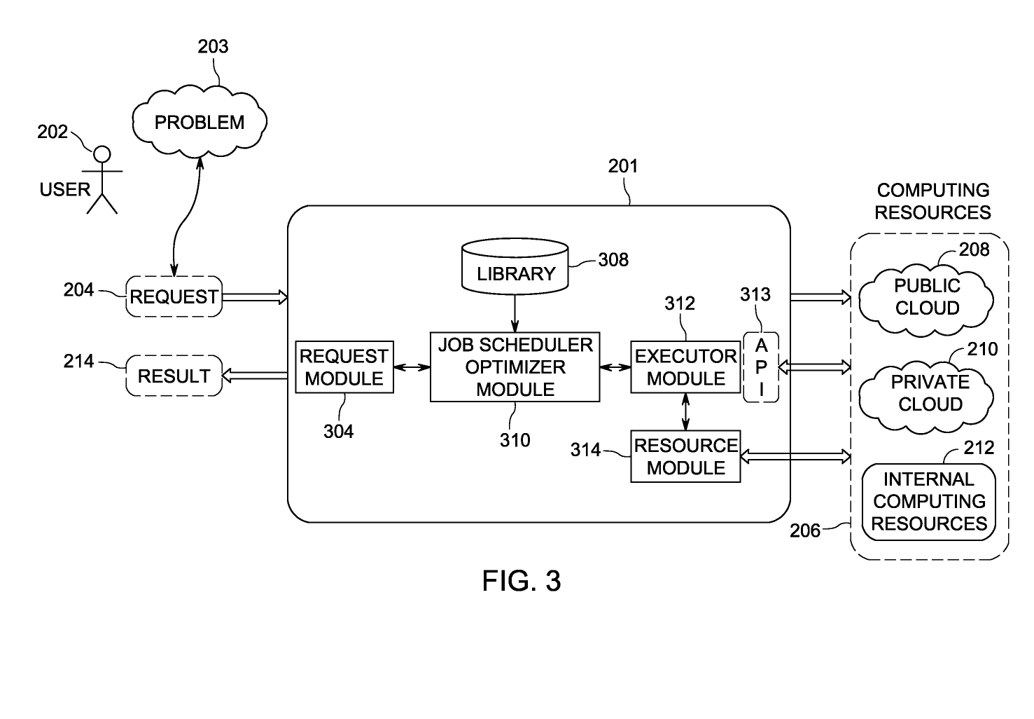

FIG. 3 is a diagram of the exemplary application environment 200 (shown in FIG. 2) showing the major components of system 201 for automatic model identification and creation with high scalability. User 202 creates and submits a request 204 to a request module 304. Request module 304 processes request 204 by creating one or more “jobs” for processing. A job scheduler/optimizer module 310 analyzes a library 308 and selects the most appropriate models and parameters to use for execution of the job, based on request 204. In some embodiments, library 308 is a database of models.

Also, in the exemplary embodiment, library 308 is a database of Machine Learning algorithms. Alternatively, library 308 is a database of other computational algorithms. Each model in library 308 includes one or more sets of computer-executable instructions compiled for different hardware and operating system architectures. The computer-executable instructions are pre-compiled binaries for a given architecture. Alternatively, the computer-executable instructions may be un-compiled source code written in a programming or scripting language, such as Java and C++. The number of algorithms in library 308 is not fixed, i.e., algorithms may be added or removed. Machine learning algorithms in library 308 may be scalable to data size.

Further, in the exemplary embodiment, a resource module 314 determines and assigns a subset of computing resource from computing resources 206 appropriate for the job. Once the job has a subset of computing resources assigned, an executor module 312 manages the submission of the job to the assigned computing resources. To communicate with the various computing resources 206, executor module 312 utilizes API modules 313. The operations of each system component are explained in detail below.

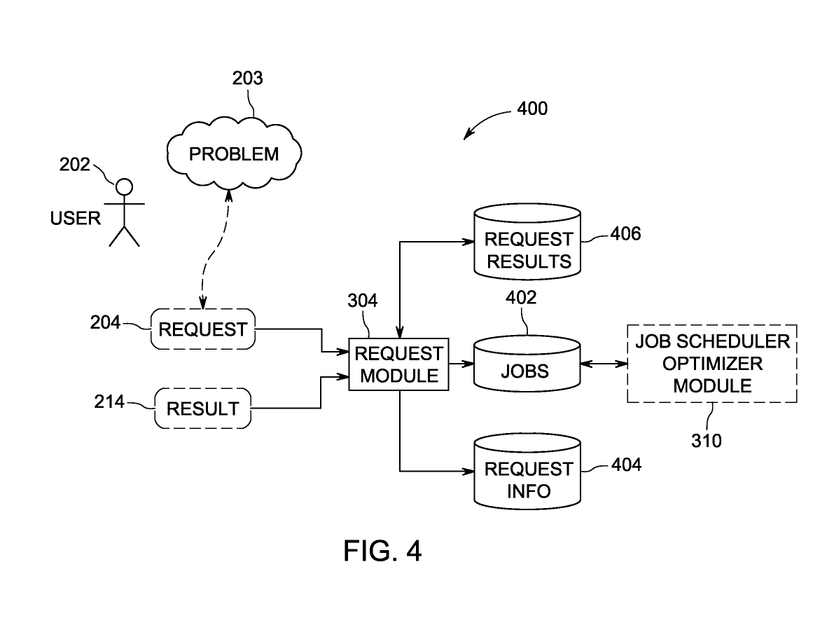

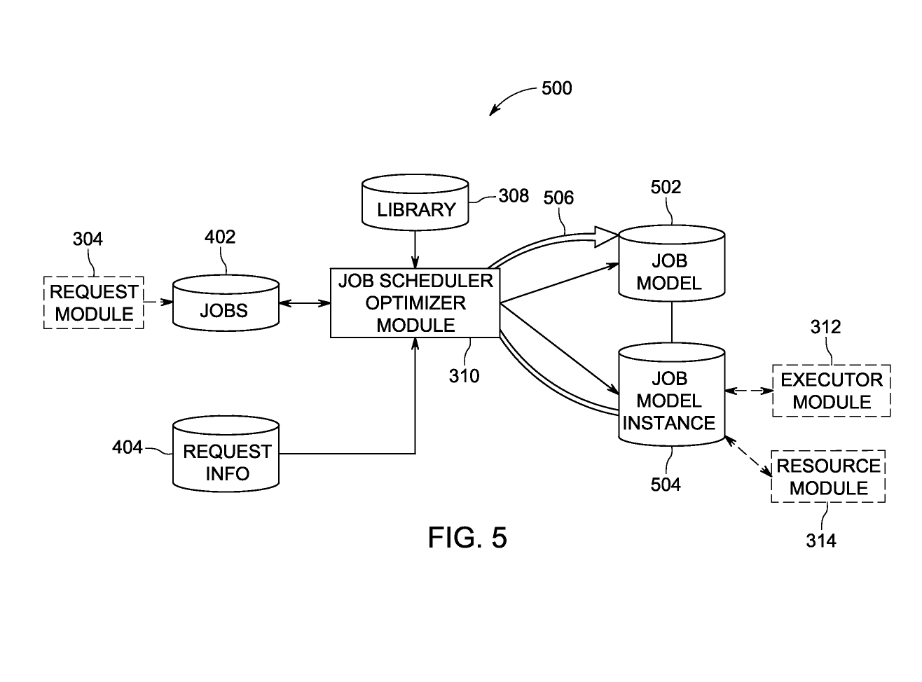

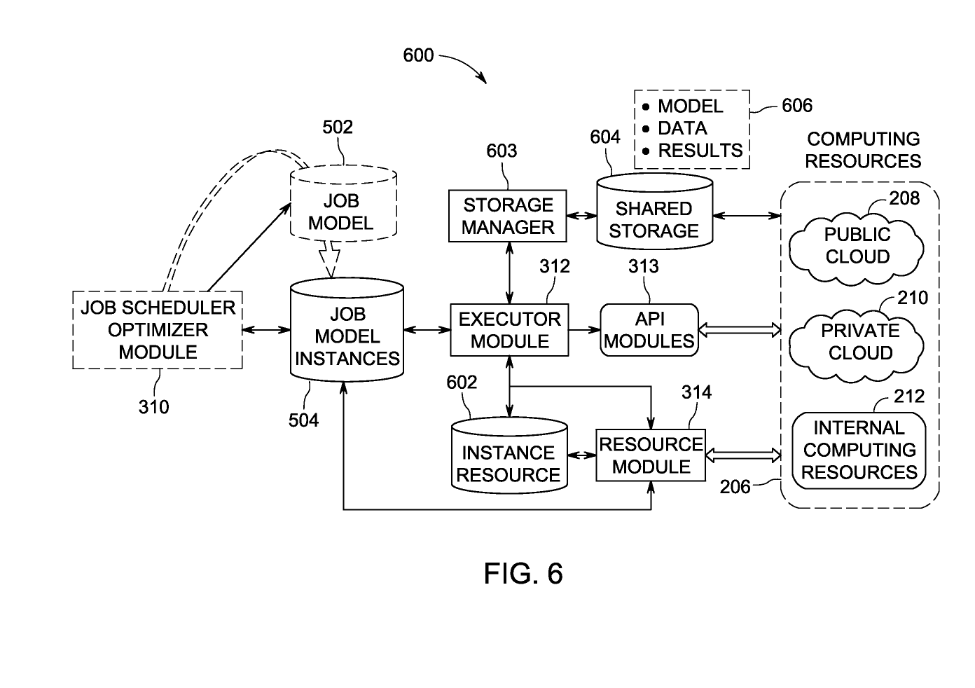

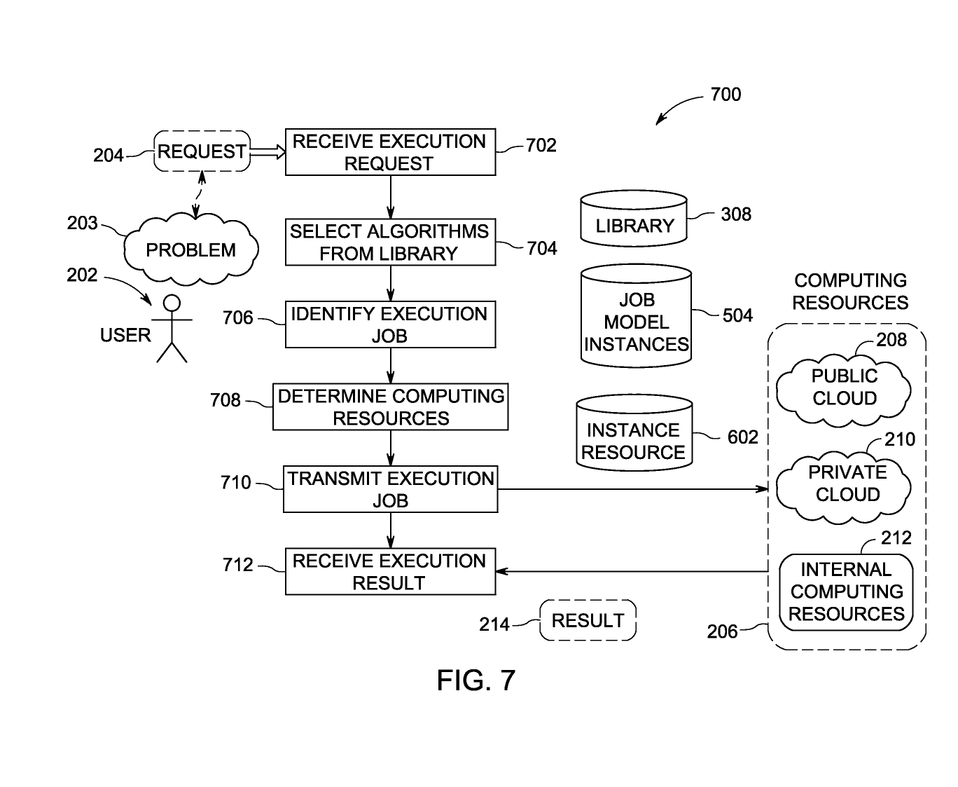

In FIGS. 4-8, the operation of each system 201 component is described. FIG. 4 shows exemplary request module 304. FIG. 5 shows exemplary job scheduler/optimizer module 310. FIG. 6 shows exemplary executor module 312 and resource module 314. FIG. 7 shows an exemplary illustration of system 201 including the components from FIGS. 4-6. The operations of each system component are explained in detail below.

In some embodiments, the components of system 201 communicate with each other through the use of database 164. Entry of information into a table of database 164 by one component may trigger action by another component. This mechanism of communication is only an exemplary method of passing information between components and advancing work flow. Alternatively, any mechanism of communication and work flow that enables operation of the systems and methods described herein may be used.

FIG. 4 is a data flow diagram 400 of exemplary request module 304 of system 201 (shown in FIG. 3), responsible for receiving and processing request 204 related to Machine Learning. For example, user 202 may submit request 204 asking to perform model exploration using the task of classification. This model space exploration represents a computationally intensive task which may be broken up into sub-tasks and executed across multiple computing resources in order to gain the benefits of utilizing multiple computing resources.

Also, in the exemplary embodiment, request module 304 stores request information 404 about request 204. In some embodiments, request information 404 is stored in database 164 (shown in FIG. 1). Alternatively, request information 404 may be stored in any other way, such as, without limitation, memory device 150 (shown in FIG. 1), or any way that enables operation of the systems and methods described herein. Request information 404 may include, without limitation, problem definition information, model names, model parameters, input data, label column number within data file providing the “ground truth” for training/optimization, task type, e.g., classification or clustering or regression or rule tuning, performance criteria, optimization method, e.g., grid search or evolutionary optimization, information regarding search space, e.g., grid points for grid search or search bounds for evolutionary optimization, computing requirements and preferences, data sensitivity, and encryption information. Alternatively, request information 404 may include any information that enables operation of the systems and methods described herein.

Further, in the exemplary embodiment, request module 304 creates a job 402. In some embodiments, job 402 is represented by a single row in database 164. Alternatively, request 204 may require multiple jobs 402 to satisfy request 204. For example, when user 202 enters request 204 asking to perform model exploration using classification, request module 304 enters a row in jobs 402 table indicating a new classification job, and links job 402 to its own request information 404. Job scheduler/optimizer module 310 periodically checks jobs 402 table for new, unprocessed jobs. Once scheduler/optimizer module 310 sees job 402, it will act to further process the job as described below.

Moreover, in the exemplary embodiment, request module 304 receives request results 406 once a job has been fully processed. In some embodiments, request results 406 are stored in database 164. In operation, request module 304 would receive request results 406 by noticing that a newly returned request result 406 has been written into database 164. This result processing is a later step in the overall operation of system 201 (shown in FIG. 3), and is discussed in more detail below.

FIG. 5 is a data flow diagram 500 of exemplary job scheduler/optimizer module 310 of system 201 (shown in FIG. 3), responsible for preparing jobs 402 for execution. Job scheduler/optimizer module 310 analyzes job 402 and request information 404, and selects one or more models from library 308. Based on request information 404, Job scheduler/optimizer module 310 creates one or more job models 502. For example, when job scheduler/optimizer module 310 sees a job requesting classification, job scheduler/optimizer module 310 examines request information 404 to see if a particular type of classification, such as Support Vector Machine (“SVM”) or Artificial Neural Network (“ANN”) has been specified by user 202. If no specific model has been specified, then job scheduler/optimizer module 310 will create a row in job model 502 for each type of classification appropriate and available from library 308.

Also, in the exemplary embodiment, a job model instance 504 is created by scheduler/optimizer module 310 for each job model 502. In operation, Job model instance 504 serves to further limit how and where job model 502 may be executed. Scheduler/optimizer module 310 limits job model instance 504 based on request information 404 and model restrictions, such as, without limitation, preferred computing resources specified by user 202 (shown in FIG. 3), and required platform specified by the particular model selected from library 308. For example, when job scheduler/optimizer 310 creates a job 402 for classification using SVM, job scheduler/optimizer 310 looks at the SVM model within library 308 and request information 404 for the request. If the SVM model within library has a computing restriction such as only having a compiled version of the model for 32-bit Linux, then job model instance 504 will be restricted to using only 32-bit Linux hosts. Alternatively, if request information 404 specifies only using internal computing resources 212, then job model instance 504 will be so restricted. In some embodiments, job model instance 504 may consist of one or more execution tasks that are defined by search space information as part of request information 404. The execution tasks may be distributed and executed on a plurality of computing resources in executor module 312, as discussed below.

In operation, in the exemplary embodiment, job scheduler/optimizer 310 periodically checks jobs 402 for unprocessed entries. Upon noticing new job 402, job scheduler/optimizer 310 analyzes request information 404 and selects several models from library 308. Job scheduler/optimizer 310 then creates a new row in job models 502 for each model required to process job 402. Further, job scheduler/optimizer 310 creates a job model instance 504 for each job model 502, further limiting how job model 502 is processed. Each of these job model instances 504 is created as individual rows in database 164. These job model instances 504 will be processed by executor module 312 and resource module 314, as discussed below.

Also, in some embodiments, job scheduler/optimizer 310 may perform a series of iterative jobs that requires submitting 506 additional job models 502 and job model instances 504 after receiving results from a previous job model instance 504. In some embodiments, such as where the optimization method is specified as grid search or other combinatorial optimization, submitting and processing a single set of job models 502 and job model instances 504 will suffice for satisfying job 402. In other embodiments, where optimization methods such as, without limitation, heuristic search, evolutionary algorithms, and stochastic optimization are specified, certain jobs 402 may require post-execution processing of a first set of results, followed by submission of additional sets of job models 502 and job model instances 504. This post-processing of results and submission of additional job models 502 may occur a certain number of times, or until a satisfaction condition is met. Dependent on the number of performance criteria specified in request information 404, the optimization may be either single-objective or multi-objective optimization.

FIG. 6 is a data flow diagram 600 of exemplary executor module 312 and resource module 314 of system 201 (shown in FIG. 3), responsible for assigning jobs to computing resources 206 and transmitting jobs for execution. Computing resource availability is maintained by resource module 314 using instance resource 602 table. Each row in instance resource 602 table correlates to one or more computing resource 206 which may be used to execute job model instances 504. In some embodiments, each instance resource 602 is a row stored in database 164 (shown in FIG. 1). As used herein, the term “instance resource” may refer, alternatively, to either a database table used for tracking computing resources 206, or to the individual computing resources that the table is used to track.

Also, in the exemplary embodiment, resource module 314 selects a subset of computing resources 206 and assigns those instance resources 602 to each job model instance 504 based on, without limitation, computing restrictions associated with job model instance 504, request information 404, and computing resource availability. In operation, when an instance resource 602 is assigned to job model instance 504, resource module 314 creates a row in database 164 used for tracking the assignment of instance resource 602 to job model instance 504. For example, resource module 314 sees a new job model instance 504 as requiring a set of computing resource. Resource module 314 examines computing resource restrictions within job model instance 504, and finds that there is a restriction to use only Linux nodes, but any public or private Linux nodes are acceptable. Resource module 314 then searches instance resource 602 to find a suitable set of Linux computing resources suitable for job model instance 504. The set of computing resources is then allocated to job model instance 504 for execution.

Further, in some embodiments, system 201 may maintain a second table (not shown) in database 164 that maintains a list of all of the current resources available to system 201, such that each row in instance resource 602 correlates to a row in the second table. This second table may include individual computing resources currently provisioned from public cloud 208 or private cloud 210, and may also include individual internal computing resources 212. Also, in some embodiments, system 201 may maintain a third table (not shown) in database 164 that maintains a list of all of the computing resource providers, such that each individual computing resource listed in the second table correlates to a provider listed in the third table.

Moreover, in some embodiments, resource module 314 considers request 204 and/or request information 404 when deciding how to allocate resources. Request 204 may include cost, time, and/or security restrictions relative to computing resource utilization, such as, without limitation, using no-cost computing resources, using computing resources with a limited cost rate per node, using computing resources up to a fixed expense amount, time constraints, using only private computing resources, and using secure computing resources. For example, if user 202 had specified a limitation to only using “secure” hosts in request, or to not spending more than a given dollar limit to execute the request, then resource module 314 would factor those additional limitations into the selection process during resource assignment. Alternatively, job scheduler/optimizer module 310 may have considered request 204 and/or request information 404 when adding restrictions to job model instance 504.

Also, in the exemplary embodiment, resource module parallelizes execution of job model instance 504 by using multiple instance resources 602 to satisfy execution of job model instance 504. As used herein, “parallelization” is the process of breaking a single, large job up into smaller components and executing each small component individually using a plurality of computing resources. In some embodiments, job model instance 504 may be distributed across model parameters, i.e., each computing resource would get all of the training data but only a fraction of the model parameters. Alternatively, any other method of parallelizing job model instance 504 that enables operation of system 201 as described herein may be used, such as, without limitation, distributing across training data, i.e., each computing resource would get all model parameters, but only a fraction of training data, or distributing both training data and model parameters. Further, in some scenarios, job model instance 504 may be parallelized across heterogeneous computing resources, i.e., the set of instance resources 602 allocated to job model instance 504 is heterogeneous. Moreover, in some scenarios, job model instance 504 may be parallelized across multiple sources of computing resources, e.g., a portion of job model instance 504 being executed by public cloud 208, and another portion being executed by private cloud 210 or internal computing resource 212.

In operation, in the exemplary embodiment, resource module 314 periodically checks for new job model instances 504. When resource module 314 notices new job model instances 504 that do not yet have resources assigned, resource module 314 consults instance resource 602 to find appropriate computing resources, and assigns appropriate, currently-unutilized instance resources 602 to job model instances 504. Resource module 314 looks for instance resources 602 that satisfy, without limitation, platform requirements of the model, such as operating system and size of processors and memory, and minimum to maximum number of cores specified by the model. In some embodiments, if at least the minimum number of required nodes is not available, then job model instance 504 remains unscheduled, and will be examined again at a later time. In the exemplary embodiment, resource module 314 will decide whether or not to request more resources, based on factors such as, without limitation, the number of requests currently queued, the types of models requested, the final solution quality required, cost and time constraints, the current quality achieved relative to cost and time constraints, and estimated resources required to run each model. If more resources will likely be required, then resource module 314 may request more computing resources 206 from public clouds 208 or private cloud 210 to bring more instance resources 602 into the available pool of resources. For example, and without limitation, if resource module 314 assesses that it can meet the time requirements imposed by request 204 for finding a high quality solution based on the number of instance resources 602 currently engaged, it need not engage additional instance resources 602, since there may be an extra cost incurred as a result. In some embodiments, resource module 314 uses a lookup table which includes the performance metrics mentioned above, and created based on historical performance on previous similar problems. In some embodiments, resource module 314 may have a maximum number of resources that may be utilized at one time, such that resource module 314 may only provision up to this maximum amount. Once instance resources 602 have been assigned to job model instance 504, executor module 312 will continue processing the job model instance 504 using the instance resource 602, as described below.

Also, in the exemplary embodiment, executor module 312 utilizes API modules 313 to transmit job model instances 504 to computing resources 206. Executor module 312 is responsible for communicating with individual computing resources 206 to perform functions such as, without limitation, provisioning new computing resources, transmitting job model instances 504 to computing resources 206 for execution, receiving results from execution, and relinquishing computing resources no longer needed.

Further, in the exemplary embodiment, executor module 312 submits job model instance 504 to instance resource 602 for execution. Instance resource 602 is one or more computing resources 206 from sources including public clouds 208, private clouds 210, and/or internal computing resources 212. To facilitate communication with each source of computing resource, executor module 312 utilizes API modules 313. Each source of computing resources 206 has an associated API. An API is a communications specification created as a protocol for communicating with a particular program, e.g., in the case of a cloud provider, the cloud provider's API creates a method of communicating with the cloud provider and the cloud resources, for performing functions such as, without limitation, provisioning new computing resources, communicating with currently-provisioned computing resources, and releasing computing resources. Each API module 313 communicates with one source of computing resources, such as, without limitation, Amazon EC2®, or an internal high-availability cluster of private servers. An API module 313 for an associated source of computing resources must be included within system 201 in order for resource module 314 to provision and allocate job model instances 504 to that source of computing resources, and in order for executor module 312 to execute job model instances 504 using that source of computing resources. In some embodiments, job model instance 504 will have multiple instance resources 602 assigned from different sources, and will engage multiple API modules to communicate with each respective computing resource.

In operation, in the exemplary embodiment, executor module 312 periodically checks job model instances 504, looking for job model instances 504 that have computing resources allocated and which are prepared for execution. Executor module 312 examines instance resources 602 to determine which source of computing resource has been allocated to job model instance 504, then transmits a sub-task associated with execution of job model instance 504 to the particular computing resource using its associate API module. For example, if job model instance 504 has been assigned 10 Linux nodes, 8 from an internal Linux cluster, and 2 from a public cloud, then executor would engage the API module associated with the internal Linux cluster to execute the 8 sub jobs on the internal Linux cluster, and would also engage the API module associated with the public cloud provider to execute the 2 sub jobs on the public cloud. In some embodiments, executor module 312 submits the entire job model instance 504 task to a single instance resource 602.

Also, in the exemplary embodiment, executor module 312 periodically polls instance resources 602 to check for completion of the assigned sub-tasks related to job model instance 504. Executor module aggregates results from multiple sub-tasks and returns the aggregated results back to job scheduler/optimizer module 310. Executor module 312 receives results data 606 directly from instance resource 602, i.e., from the individual server that executed a portion of job model instance 504. Alternatively, executor module 312 receives results data 606 from a storage manager 603 or shared storage 604, described below. For example, if job model instance 504 was assigned to 10 instance resources 602, then executor module 312 distributes sub-tasks to each of the 10 instance resources 602, and subsequently polls them until completion. Once results data 606 from all 10 instance resources 602 are collected, they are aggregated and returned to job scheduler/optimizer module 310. In some scenarios, job scheduler/optimizer module 310, depending on the type of job, analyzes the aggregated result of job model instance 504 and returns the result 214 (shown in FIG. 3). In other scenarios, job scheduler/optimizer module 310 may analyze the aggregated result of job model instance 504, but then execute a further one or more job model instances 504 before returning a final result 214. The result of the first job model instance 504 may be used in the subsequent one or more job model instances 504. In the exemplary embodiment, job scheduler/optimizer returns the aggregated result to request module 304 (shown in FIG. 3). Alternatively, job scheduler/optimizer module 310 returns results of job model instance 504 to user 202 (shown in FIG. 3).

Further, in some embodiments, executor module 312 may monitor the status of instance resources 602 for any failure associated with the assigned sub-task related to job model instance 504 to which it has been assigned. For example, and without limitation, a run-time error during execution, or an operating system failure of the instance resource 602 itself. Upon recognizing a failure, executor module 312 may restart the sub-task related to job model instance 504 on the original instance resource 602, or may reassign the sub-task to an alternate instance resource 602. In other embodiments, executor module 312 may be configured as a second layer of fault tolerance, allowing a cloud service provider to deliver the first layer of fault tolerance through their own proprietary mechanisms, and only implementing the above-described mechanisms if executor module 312 senses failure of the cloud service provider's fault tolerance mechanism.

Further, in the exemplary embodiment, resource module 314 performs the task of provisioning and releasing computing resources. In operation, request 204 may require system 201 to utilize more computing resources than are currently provisioned and available. Resource module 314 utilizes API modules 313 to provision new nodes upon demand, as described above. Resource module 314 also releases computing resources when they are no longer required. In some embodiments, resource module 314 may release resources from instance resources 602 based on demand, or cost. For example, and without limitation, resource module 314 may release a node during a time of the day where peak demand increases the cost of the instance resource 602 based on time constraints and cost constraints of request 204, and may reacquire the instance resource 602 when the peak demand period has ended.

Moreover, in some embodiments, system 201 includes a storage manager 603 and shared storage 604. Shared storage 604 may be, without limitation, private storage or cloud storage. Shared storage 604 is accessible by computing resources 206 in such a way as to allow computing resources 206 to store data 606 associated with execution of job model instances 504. Shared storage 604 may be used to store data 606, such as, without limitation, model information, model input data, and execution results. Shared storage 604 may also be accessible by storage manager 603, which may act to pass data 606 regarding the execution results back through system 201. Storage manager 603 may also allocate shared storage 604 to computing resources 206, and may allocate shared storage 604 based on a request from executor module 312 or job scheduler/optimizer module 310.

FIG. 7 is a block diagram of an exemplary method 700 of automatic model identification and creation by provisioning heterogeneous computing resources 206 for Machine Learning using system 201 (shown in FIG. 3). Method 700 is implemented by at least one computing system 120 including at least one processor 152 (shown in FIG. 1) and at least one memory device 150 (shown in FIG. 1) coupled to the at least one processor 152. An execution request 204 is received 702.

Also, in the exemplary embodiment, one or more algorithms are selected 704 from library 308. Each algorithm in library 308 includes one of source code and machine-executable code. Selecting 704 a subset of algorithms is based at least partially on execution request 204. One or more execution jobs, e.g. job model instances 504, are identified 706 for execution. Each of the one or more execution jobs includes at least one algorithm from the library 308.

Further, in the exemplary embodiment, a subset of computing resources is determined 708 from a plurality of computing resources 206. Plurality of computing resources 206 includes one of at least one internal computing resource, i.e., private cloud 210 and internal computing resource 212, and at least one third-party computing resource, i.e., public cloud 208, and a plurality of third-party computing resources, i.e., public cloud 208. Computing system 120 transmits 710 at least one of the one or more execution jobs to at least one computing resource 206 of the subset of computing resources, and receives 712 an execution result 214.

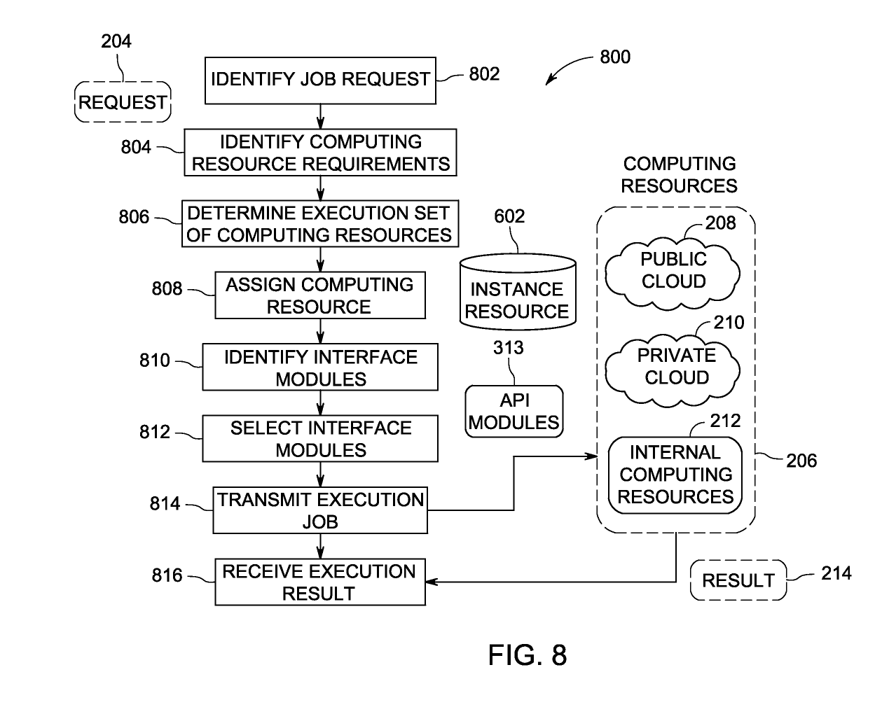

FIG. 8 is a block diagram of another exemplary method 800 of automatic model identification and creation by provisioning heterogeneous computing resources 206 for Machine Learning using system 201 (shown in FIG. 3). Method 800 is implemented by at least one computing system 120 including at least one processor 152 (shown in FIG. 1) and at least one memory device 150 (shown in FIG. 1) coupled to the at least one processor 152. A job request 204 comprising one or more individual jobs is identified 802. For job request 204, one or more computing resource requirements are identified 804.

Also, in the exemplary embodiment, an execution set of computing resources is determined 806 from a pool of computing resources based at least partially on the one or more computing resource requirements. Computing resources 206 includes one of at least one internal computing resource, i.e., private cloud 210 and internal computing resource 212, and at least one external computing resource, i.e., public cloud 208, and a plurality of external computing resources, i.e., public clouds 208. Each computing resource of the pool of computing resources defines an associated API that facilitates communication between system 201 (shown in FIG. 3) and the computing resource. From the execution set of computing resources, a first computing resource is assigned 808 to a first individual job of the one or more individual jobs, e.g., job model instances 504 (shown in FIGS. 5-6).

Further, in the exemplary embodiment, a plurality of interface modules 313 is identified 810. Each interface module is configured to facilitate communication with one or more computing resources 206 using the associated API. An interface module is selected 812 from plurality of interface modules 313 based at least in part on facilitating communication with the first computing resource. Computing system 120 transmits 814 the first individual job for execution to the first computing resource using the first interface module, and receives 816 an execution result. As used herein, the term “interface modules” refers to API modules.

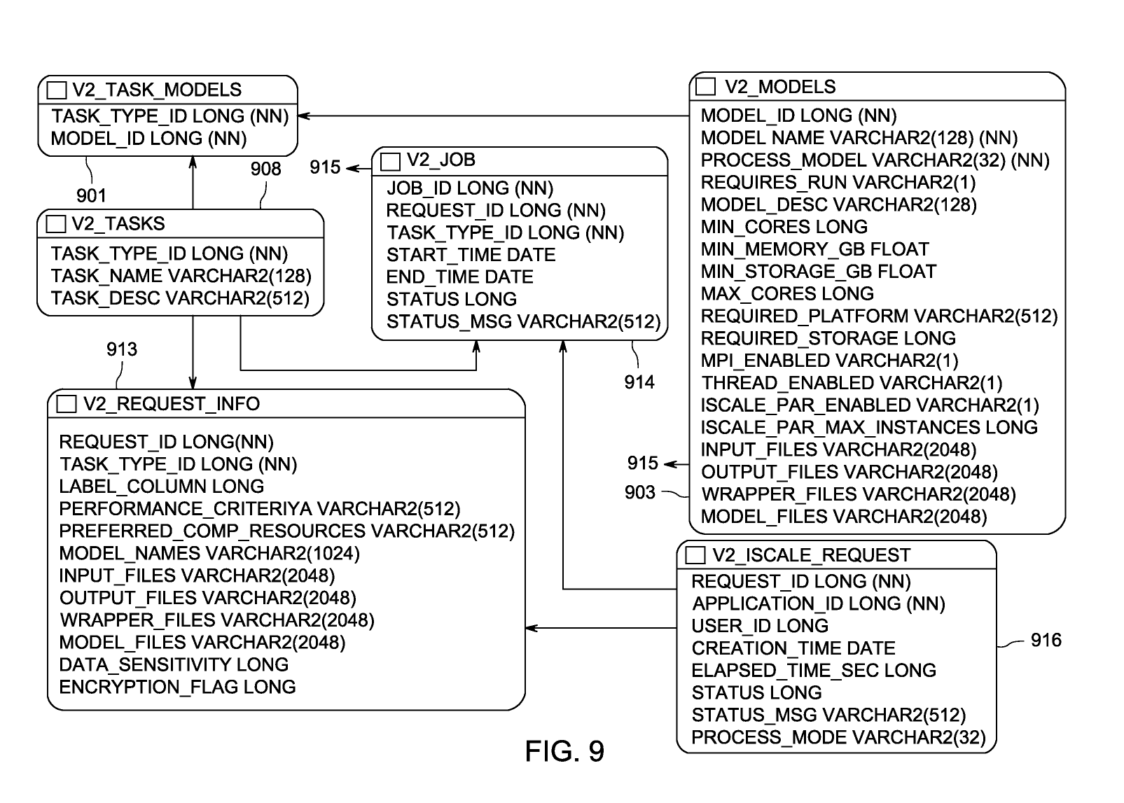

FIGS. 9-11 show a diagram of an exemplary database table structure 900 for system 201 (shown in FIG. 2) in three parts. Each element in FIGS. 9-11 represents a separate table in database 164, and the contents of each element show the table name and the table structure, including field names and data types. The interconnections between elements indicate at least a relation between the two tables, such as, without limitation, a common field. In operation, each table is utilized by one or more of the components of system 201 to track and process the various stages of execution of job request 204 (shown in FIG. 2). The relationships between the tables and the components of system 201 are described below.

FIG. 9 is a block diagram showing a first portion of exemplary database table structure 900 for system 201 (shown in FIG. 3), showing the primary tables used by request module (shown in FIG. 3). Request 916 is a high level table containing information regarding requests 204 (shown in FIG. 3). Detailed information for request 204 is stored in Request Info 913, and includes, without limitation, information regarding performance criteria, computing resource preferences and limitations, model names, input and output files, wrapper files, model files, and information about data sensitivity and encryption. Job 914 is a table containing information relating to processing request 204. Job 914 ties together information from tasks 908 and Request 916, and is used to initiate processing further processing by system 201. A single request 204 may generate one or more entries in Job 914. Models 903 is a table that maintains a library of machine learning models available to system 201. Tasks 908 is a table that maintains task types for the variety of models that system 201 can handle. Task Models 901 is a table that associates Models 903 with their respective task types.

In operation, in the exemplary embodiment, user 202 (shown in FIG. 2) submits request 204 to system 201. New requests 302 are received and processed by request module 304 (shown in FIG. 3). Upon receiving request 204, request module 304 creates a new row in Request 916, and a new row in Request Info 913. Information associated with request 204 is stored in Request Info 913. Request 204 may specify which Model 903 user 202 wants to be used. Alternatively, user 202 may specify a task type, from which system 201 executes one or more Models 903 associated with that task type. Request module 304 then creates a new row in Job 914. The creation of the Job 914 entries serves as an avenue of communication to job scheduler/optimizer module 310 (shown in FIG. 3). When job scheduler/optimizer module 310 notices new entries in Job 914 table, job scheduler/optimizer module 310 will continue processing.

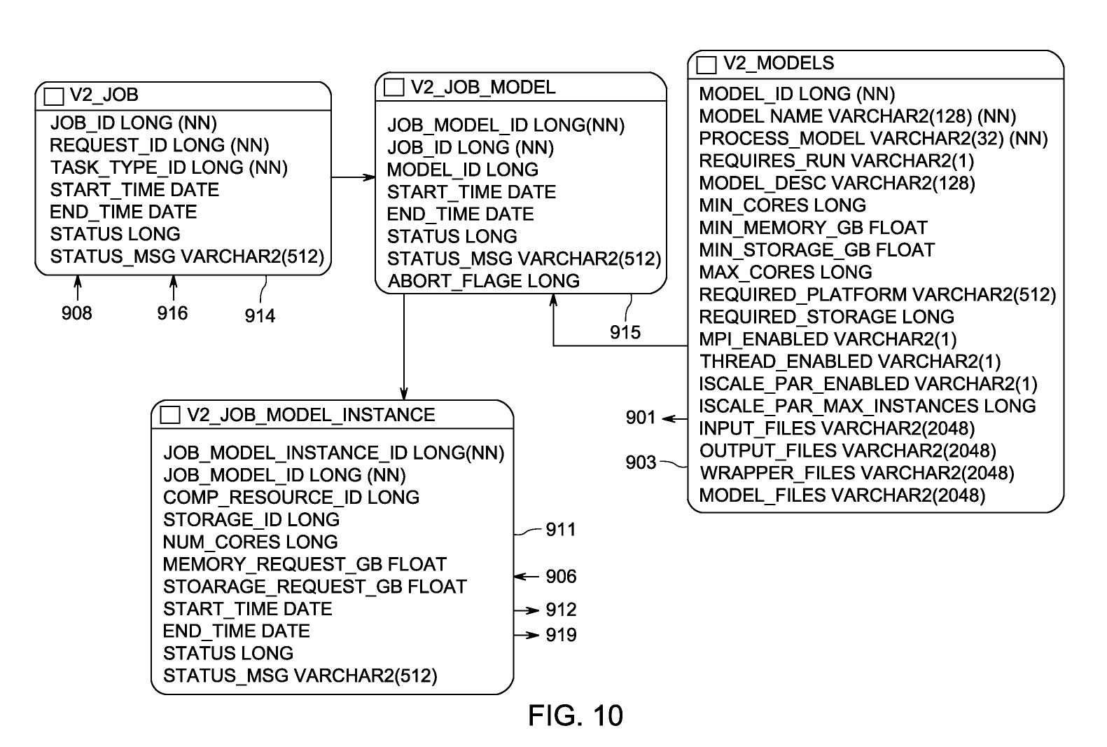

FIG. 10 is a block diagram showing a second portion the exemplary database structure 900 for system 201 (shown in FIG. 3), showing the primary tables used by job scheduler/optimizer module (shown in FIG. 3). A Job Model 915 table includes information about jobs that need to be executed to complete request 204 (shown in FIG. 3). Each entry in Job Model 915 is associated with a single entry in Job 914 table, as well as a single entry in Models 903. A Job Model Instance 911 table includes information related to entries in Job Model 915, further refining restrictions of Job Model 915 based on, for example, and without limitation, computing resource limitations based on the particular model, and computing resource limitations based on request 204 (shown in FIG. 3). In the exemplary embodiment, Job Model Instance 911 includes a single row for each row in Job Model 915. Alternatively, a single row in Job Model 915 may result in multiple Job Model Instances 911.

In operation, in the exemplary embodiment, job scheduler/optimizer module 310 (shown in FIG. 3) notices a new, unprocessed row appear in Job 914. Job scheduler/optimizer module 310 selects n models 903, and creates n new rows in Job Model 915 table. Each of these new rows in Job Model 915 represents a sub-task, affiliated with an individual model from Models 903, that needs to be executed to complete request 204. Job scheduler/optimizer module 310 then creates n rows in Job Model Instance 911 table, each correlating to one of the n new rows in Job Model 915. Job scheduler/optimizer module 310 considers and formulates restraints for each Job Model 915 when creating Job Model Instance 911. The creation of the Job Model Instance 911 entries serves as an avenue of communication to resource module 314 (shown in FIG. 3) and executor module 312 (shown in FIG. 3). When resource module 314 notices new entries in Job Model Instance 911, resource module 314 will continue processing.

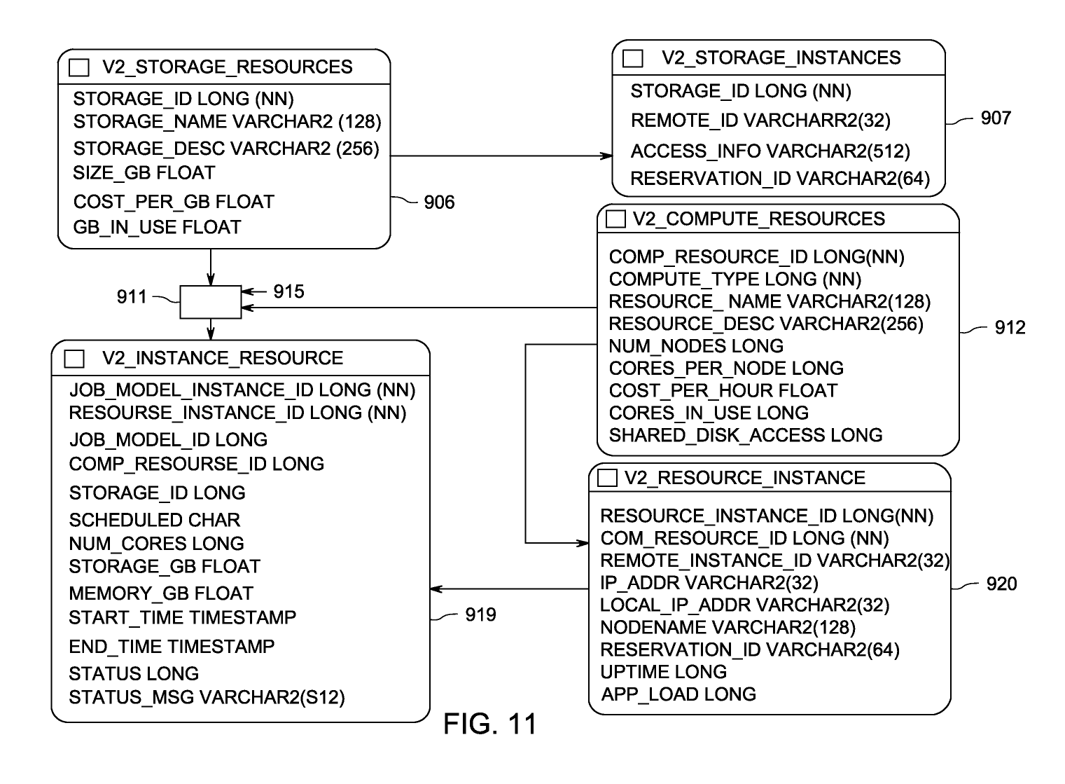

FIG. 11 is a block diagram showing a third portion of the exemplary database structure 900 for system 201 (shown in FIG. 3), showing the primary tables used by executor module (shown in FIG. 3) and resource module (shown in FIG. 3). Information about computing resources 206 (shown in FIG. 3) is maintained by three tables, Compute Resources 912, Resource Instance 920, and Instance Resource 919. Compute Resources 912 includes high-level information about sources of computing resources. Resource Instance 920 provides details regarding each individual computing resource currently provisioned to or otherwise available for use by system 201. Instance Resource 919 tracks allocation of Resource Instances 920. In the exemplary embodiment, each Resource Instance 920 has a corresponding row in Instance Resource 919 table whenever the Resource Instance 920 is assigned to perform work. Alternatively, a row in Instance Resource 919 table is created when the Resource Instance 920 starts to perform assigned work.

In operation, in the exemplary embodiment, each cloud service provider with which system 201 is configured to act has a row in Compute Resources 912. Each private cloud or internal resource may also have rows in Compute Resources 912. For example, and without limitation, Compute Resources 912 table may have an entry for Amazon EC2®, Rackspace®, Terremark®, a private internal cloud, and internal computing resources. Each row represents a source of computing services with which system 201 is configured to interact. Resource Instance 920 has a row for each individual computing device currently provisioned to or otherwise available for use by system 201. Each Resource Instance 920 will have a “parent” compute resource 912 associated with it, based on which cloud service provider, or other source, the Compute Resource 912 comes from. For example, and without limitation, when system 201 provisions 10 virtual servers from Amazon EC2®, system 201 will create 10 entries in Resource Instance 920, each of which correspond to a single Amazon EC2® virtual server. In the exemplary embodiment, for cloud resources, these rows are created and deleted as system 201 provisions and releases virtual servers from the Cloud Service Providers. Alternatively, rows may remain in the table despite release of the row's associated virtual server.

Also in operation, in the exemplary embodiment, the Resource Instances 920 are assigned to perform work, i.e., they are assigned to execute Job Model Instances 911. The table Instance Resource 919 tracks the assignment of Resource Instances 920 to job model instances 911. When a new Job Model Instance 911 is added, resource module 314 assigns a Resource Instance 920 to the Job Model Instance 911. Resource module 314 assigns Resource Instance 920 to Job Model Instance 911 based on information in Job Model Instance 911. Alternatively, executor module 312 or resource module 314 creates or updates a row in Instance Resource 919 associated with the Resource Instance 920.

Also, in the exemplary embodiment, shared storage 604 (shown in FIG. 7) may be assigned for use by Resource Instances 920. A Storage Resources 906 table includes high-level information about storage resource providers available to system 201. A Storage Instances 907 table includes information about individual storage instances that have been provisioned by or assigned for use by system 201. In operation, the execution of a Job Model Instance 911 may require use of a Storage Instance 907. Storage manager 603 (shown in FIG. 7) assigns a Storage Instance 907, i.e., shared storage 604 (shown in FIG. 7), to the Job Model Instance 911 for use during execution.

The above-described systems and methods provide ways for automatic model identification and creation through automatically provisioning computing resources from a heterogeneous set of computing resources for purposes of Machine Learning. The embodiments described herein take a request from a user, selects, from a database of models, a subset of models that meet the performance requirements specified in the user's request, and searches for a single best model or best combination of a series of models. The search process is performed by breaking up the model space into individual job components consisting of one or more models, with each model having multiple individual instances using that model. The division of the user's request into discrete units of work allows the system to leverage multiple computing resources in processing the request. The system leverages many different sources of computing resources, including both cloud computing resources from various cloud providers, as well as private clouds or internal computing resources. The system also leverages different types of computing resources, such as computing resources differing in underlying operating system and hardware architecture. The ability to leverage multiple sources of computing resources, as well as types of computing resources allows the system greater flexibility and computational capacity. The combination of automation, flexibility, and capacity makes analysis of large search spaces feasible where, before, it was a manual, time consuming process. The system also includes constraint features that can allow a user to customize a request such that it can be restricted to what type of computing resources it leverages, or how much computing resources it leverages.

An exemplary technical effect of the methods and systems described herein includes at least one of: (a) insulating the requesting user from the computational details of resource allocation; (b) leveraging different sources and types of computing resources for execution of the user's computational work; (c) leveraging distributed computing, from both internal and internet-based cloud computing providers, for processing a user's Machine Learning or other computational problems; (d) increasing flexibility and computational capacity available to users; (e) reducing human man-hours by automating the processing of a user's Machine Learning or other computational requests through the use of a models database; (f) increasing scalability to a particular problem's data size and computational complexity.

Exemplary embodiments of systems and methods for automatic model identification and creation with high scalability are described above in detail. The systems and methods described herein are not limited to the specific embodiments described herein, but rather, components of systems and/or steps of the methods may be utilized independently and separately from other components and/or steps described herein. For example, the methods may also be used in combination with other systems requiring distributed computing systems and methods, and are not limited to practice with only the automatic model identification and creation with high scalability systems and methods as described herein. Rather, the exemplary embodiments can be implemented and utilized in connection with many other concept extraction applications.

Although specific features of various embodiments may be shown in some drawings and not in others, this is for convenience only. In accordance with the principles of the systems and methods described herein, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising:
a library comprising a plurality of algorithms, each algorithm of said plurality of algorithms including at least one of source code and machine-executable code;
a request module configured to receive an execution request;
a job scheduler/optimizer module configured to:
select a subset of algorithms from said library; and
create at least one execution job based at least partially on at least one algorithm from said subset of algorithms and based at least partially on the execution request;
a resource module configured to determine a subset of computing resources from a plurality of computing resources, the plurality of computing resources comprising one of:
at least one internal computing resource and at least one external computing resource; and
a plurality of external computing resources; and
an executor module configured to transmit the at least one execution job to at least one computing resource of the subset of computing resources.

2. The system in accordance with claim 1, wherein said request module is further configured to receive the execution request at least partially from a user.

3. The system in accordance with claim 1, wherein said job scheduler/optimizer module is further configured to:
select a subset of algorithms based at least partially on at least one of a relevance of one or more algorithms of said library to the execution request, a performance requirement, and an architectural property of a computing resource in the subset of computing resources; and
create a second execution job based at least in part on a result from said at least one execution job, wherein said creating a second execution job includes determining an algorithm parameter associated with said second execution job.

4. The system in accordance with claim 1, wherein said resource module is further configured to determine a subset of computing resources based at least in part on at least one of the execution request and at least one algorithm in said subset of algorithms.

5. The system in accordance with claim 1, wherein said resource module is further configured to determine a subset of computing resources comprising a set of heterogeneous computing resources.

6. The system in accordance with claim 1, wherein said request module is further configured to receive resourcing instructions, and wherein said resource module is further configured to determine the subset of computing resources based at least in part on the resourcing instructions.

7. The system in accordance with claim 1, wherein said request module is further configured to receive an execution request which includes a machine learning problem, and wherein said library further comprises a plurality of machine learning algorithms configured to facilitate solving machine learning problems.

8. A method for executing computer jobs, said method implemented by at least one computer device including at least one processor and at least one memory device coupled to the at least one processor, said method comprising:
receiving an execution request;
selecting a subset of algorithms from a library including a plurality of algorithms, wherein each algorithm in the library includes one of source code and machine-executable code, and wherein selecting a subset of algorithms is based at least partially on the execution request;
identifying a first set of one or more execution jobs, wherein each of the first set of one or more execution jobs includes at least one algorithm from the subset of algorithms;
determining a subset of computing resources from a plurality of computing resources, wherein the plurality of computing resources includes one of:
at least one internal computing resource and at least one third-party computing resource; and
a plurality of third-party computing resources;
transmitting, by the at least one computer device, at least one of the first set of one or more execution jobs to at least one computing resource of the subset of computing resources; and
receiving an execution result.

9. The method in accordance with claim 8, wherein receiving an execution request comprises receiving an execution request at least partially from a user.

10. The method in accordance with claim 8, wherein selecting a subset of algorithms is based at least partially on one or more of a relevance of one or more algorithms of the library to the execution request, a performance requirement, and an architectural property of a computing resource in the subset of computing resources, and further comprising identifying a second set of execution jobs based at least in part on a result from the first set of one or more execution jobs, wherein identifying a second set of execution jobs includes determining an algorithm parameter associated with the second set of execution jobs.

11. The method in accordance with claim 8, wherein determining a subset of computing resources is based at least in part on the execution request.

12. The method in accordance with claim 8, wherein determining a subset of computing resources includes determining a subset of computing resources comprising a set of heterogeneous computing resources.

13. The method in accordance with claim 8 further comprising receiving a resourcing instruction, and wherein determining a subset of computing resources is based at least in part on the resourcing instruction.

14. The method in accordance with claim 8, wherein receiving an execution request comprises receiving a machine learning problem, and wherein selecting a subset of algorithms comprises selecting a subset of algorithms from a library including a plurality of machine learning algorithms configured to facilitate solving machine learning problems.

15. The method in accordance with claim 8, further comprising identifying a second set of one or more execution jobs based at least partially on the execution result.

16. One or more computer-readable storage media having computer-executable instructions embodied thereon, wherein when executed by at least one processor, the computer-executable instructions cause the processor to:
receive an execution request;
determine a subset of computing resources from a plurality of computing resources, wherein the plurality of computing resources comprises:
at least one internal computing resource and at least one third-party computing resource; and
a plurality of third-party computing resources;
select a subset of algorithms from a library comprising a plurality of algorithms, wherein each algorithm in the library is one of source code and machine-executable code, and wherein selecting the subset of algorithms comprises selecting based at least in part on the execution request;
identify one or more execution jobs to be executed, wherein each of the one or more execution jobs comprises at least one algorithm from the subset of algorithms;
transmit at least one of the one or more execution jobs to at least one computing resource of the subset of computing resources; and
receive an execution result.

17. The computer-readable storage media in accordance with claim 15, wherein the computer-executable instructions further cause the processor to receive an execution request at least partially from a user.

18. The computer-readable storage media in accordance with claim 15, wherein the computer-executable instructions further cause the processor to:
select a subset of algorithms based at least partially on at least one of a relevance of each algorithm to the execution request, a performance requirement, and an architectural property of a computing resource in the subset of computing resources; and
identify a second execution job based at least in part on a result from the one or more execution jobs, wherein identifying a second execution job includes determining an algorithm parameter associated with said second execution job.

19. The computer-readable storage media in accordance with claim 15, wherein the computer-executable instructions further cause the processor to determine a subset of computing resources comprising a set of heterogeneous computing resources.

20. The computer-readable storage media in accordance with claim 15, wherein the computer-executable instructions further cause the processor to receive resourcing instructions, and wherein the computer-executable instructions further cause the processor to determine a subset of computing resources based at least in part on the resourcing instructions.
